(19) United States
(12) Patent Application Publication
(10) Pub. No.: US 2009/0055774 A1
(43) Pub. Date: Feb. 26, 2009

(54) Method For Operating A Navigation System

(76) Inventor: Steffen Joachim, Tauberbischofsheim (DE)

Correspondence Address: QUARLES & BRADY LLP, 411 E. WISCONSIN AVENUE, SUITE 2040, MILWAUKEE, WI, 53202-4497, US

(21) Appl. No.: 12/178,787

(22) Filed: Jul. 24, 2008

(30) Foreign Application Priority Data
Aug. 8, 2007 (DE) 10 2007 037 386.6

(51) Int. Cl. G06F 3/048; G01C 21/20

(52) U.S. Cl. 715/810; 701/208

(57) ABSTRACT

A method for operating a navigation system includes the following steps:
a) calculating and displaying a map image on a display device, wherein the map image represents at least a section of a geographic area;
b) selecting locations to be highlighted (Points of Interest, POI) that lie in the region of the geographic area displayed and are respectively assigned to one POI-symbol in the map image from a data base, and
c) displaying the POI-symbols in the map image, wherein the POI-symbols that symbolize the locations to be highlighted within a common local area are displayed in the form of a common combination symbol such that one combination symbol respectively represents several POI-symbols, wherein the combination symbol features at least one display area, in which at least one POI-symbol can be displayed, and wherein the POI-symbols assigned to the combination symbol are alternately displayed in the display area.

### CROSS-REFERENCE TO RELATED APPLICATION

This application claims the priority benefit of German Patent Application No. 10 2007 037 386.6 filed on Aug. 8, 2007, the contents of which are hereby incorporated by reference as if fully set forth herein in their entirety.

### STATEMENT CONCERNING FEDERALLY SPONSORED RESEARCH OR DEVELOPMENT

Not applicable.

### FIELD OF THE INVENTION

The invention pertains to a method for operating a navigation system and in particular, a method of operating a navigation system that displays at least one point of interest.

### BACKGROUND OF THE INVENTION

In known navigation systems such as, for example, mobile navigation devices for motor vehicles, it is common practice to display a map image on a display device. This map image represents a section of a geographic area and also shows, for example, the corresponding road network in order to provide the user with a corresponding overview.

A navigation system of the generic type also contains a database, in which locations to be highlighted are stored, wherein these locations are referred to as “Points of Interest” (POI) below. These Points of Interest may consist, for example, of police stations, hospitals, filling stations, rest areas, parking lots or the like. These Points of Interest can be symbolized by so-called POI-symbols in the map image. During the configuration of a map image, the Points of Interest situated in the area of the map image to be displayed are selected from the database. The selected POI-symbols are then displayed in the map image.

Depending on the scale of the map image shown, it may be problematic if several Points of Interest lie in a common local area, i.e., if they are arranged closely adjacent to one another. Due to this close proximity of the Points of Interest, the correspondingly assigned POI-symbols overlap in the map image and cover one another accordingly. The recognizability of the POI-symbols is no longer ensured in such instances.

In order to solve this problem, DE 102 30 479 A1 and U.S. Pat. No. 7,076,741 B2 propose the utilization of combination symbols. In instances in which several Points of Interest lie in a common local area such that the assigned POI-symbols cannot be displayed without overlapping, a combination symbol is displayed instead of the individual POI-symbols. This combination symbol informs the user that several Points of Interest are situated at the corresponding location.

In order to obtain the information on the Points of Interest assigned to the combination symbol, the user needs to access the combination symbol, for example, by means of a touch-screen.

After accessing the combination symbol, the information on the individual Points of Interest assigned to the combination symbol, which is stored in the combination symbol, is displayed adjacent to one another.

This type of display has the disadvantage that the POI-symbol information assigned to the combination symbol is only displayed for the user after corresponding user interaction. This restricts the user friendliness. If the navigation system is used in a motor vehicle, this type of display also represents a potential safety risk because the user is briefly distracted from traffic while the combination symbol is accessed.

### SUMMARY OF THE INVENTION

Based on this state of the art, the present invention aims to propose a new method for operating a navigation system that utilizes combination symbols and makes it possible to improve the user friendliness, as well as the traffic safety.

This objective is attained in a preferred embodiment of the invention in which the method for operating a navigation system includes the following steps:
a) calculating and displaying a map image on a display device, wherein the map image represents at least a section of a geographic area;
b) selecting locations to be highlighted (Points of Interest, POI) that lie in the region of the geographic area displayed and are respectively assigned to one POI-symbol in the map image from a data base, and
c) displaying the POI-symbols in the map image, wherein the POI-symbols that symbolize the locations to be highlighted within a common local area are displayed in the form of a common combination symbol such that one combination symbol respectively represents several POI-symbols, in which the combination symbol features at least one display area, in which at least one POI-symbol can be displayed, wherein the POI-symbols assigned to the combination symbol are alternately displayed in the display area.

The inventive method is based on the fundamental notion to provide a display area on the combination symbol that has no fixed image content. In this case, the size of the display area is at least so large that at least one POI-symbol can be displayed in the display area. When the map image is displayed, the POI-symbols assigned to the combination symbol are then alternately displayed in the display area, i.e. the individual POI-symbols are displayed on the display are in a rotating fashion, for example. Due to this staggered display of the individual POI-symbols, it is ensured that only a minimal section of the map image shown needs to be available for displaying the individual POI-symbols. However, the user is provided with all information assigned to the combination symbol over an extended period of time, namely without requiring any user interaction. Consequently, the user friendliness and the traffic safety are improved because all information of the combination symbol is displayed for the user in compact form without any control measures on the part the user.

In carrying out the inventive method, it is not absolutely imperative to alternately display the POI-symbols in the display area of the combination symbol constantly. According to one preferred embodiment, it is therefore proposed that the display area of the combination symbol can be switched off. In this context, switching off the display area merely means that POI-symbols are not alternately displayed in the switched-off state. However, a single POI-symbol can be permanently displayed in the switched-of state. Alternatively, it would also be conceivable to display a symbol surface such as, for example, a monochrome surface on the combination symbol when the display area is switched off.

The display area essentially may be switched off in any suitable way. It would be possible, for example, to enable the user to switch off the display area of one or more combination symbols by actuating a corresponding actuating element, for example, a button or a certain area of the touch-screen. Alternatively or additionally, the display area may also be switched off by configuring the navigation system accordingly. It would also be conceivable that the combination symbols are initially switched off in their basic state, i.e., after the navigation system is restarted, and only switched on due to subsequent events such as, for example, a corresponding user interaction.

The POI-symbols essentially may be alternately displayed in any suitable way. In the simplest variation, the POI-symbols are successively displayed in a rotating fashion. In order to realize an optically appealing display, however, it is advantageous to crossfade the POI-symbols during their respective alternation by means of a suitable crossfading method. This crossfading may consist of turning the individual POI-symbols, in the manner of horizontally or vertically scrolling through the individual POI-symbols and/or in the manner of morphing one POI-symbol into another POI-symbol.

In order to trigger certain display effects, it is furthermore advantageous to not only display the POI-symbols alternately, but to also make it possible to influence the display of the combination symbol and/or the display of the POI-symbols assigned to the combination symbol by accessing the POI-symbols.

In this case, the combination symbol can be accessed in a particularly simple and accurate fashion by actuating a correspondingly provided actuating element, for example, by pushing a button, clicking on the combination symbol with a mouse pointer or the user touching a touch-screen.

As an alternative to this type of access by means of a user interaction, it is advantageous, particularly in mobile navigation devices, if the combination symbol can also be accessed in dependence on the current position determined by the navigation device. As soon as the navigation device approaches the local area containing the Points of Interest assigned to the combination symbol, the combination symbol can be automatically accessed without direct user interaction. This makes it possible, in particular, to automatically display the information combined in the combination symbol in broader form when the user approaches the corresponding local area of the combination symbol. It would also be conceivable to influence the rotating display of the POI-symbols in dependence on the vehicle position. For example, the speed of the successive display of the POI-symbols could be increased as the current position approaches the combination symbol.

The display of the combination symbol or the POI-symbols assigned to the combination symbol essentially may be influenced in any suitable way when they are accessed. According to a first variation, it is proposed that the display areas of the combination symbols are switched off in a basic state. The inventive alternating display of the POI-symbols in the display area of the combination symbol is not started until the combination symbol is accessed, for example, by means of a mouse click or when the current position approaches the local area of the combination symbol.

Alternatively or additionally, it would also be possible to simultaneously display several POI-symbols assigned to the combination symbol adjacent to one another. If the current position of a navigation device approaches, for example, the local area of a combination symbol, all individual POI-symbols assigned to the combination symbol can be automatically displayed adjacent to one another in this fashion in order to fully inform the user of the options at the corresponding location. It would also be conceivable to achieve a corresponding expansion of the combination symbol with direct user interaction.

The combination symbol could conceivably be displayed in many different variations. In order to directly provide the user with the intuitive impression that the combination symbol represents several POI-symbols, it is particularly advantageous if the combination symbol features a stack symbol in addition to the display area for the alternating display of the POI-symbols. This stack symbol needs to be graphically designed in such a way that it symbolizes a stack with at least one panel. This can be achieved, for example, with a corresponding time difference between individual panel symbols in the stack symbol. The combined display of the display area and the stack symbol makes it possible to design combination symbols that enable the user to intuitively recognize that the POI-symbols displayed in the display area are part of a plurality of individual POI-symbols that, in turn, are symbolized by the stack symbol.

The utilization of stack symbols also makes it possible to code the number of POI-symbols represented by the combination symbol such that it can be easily recognized intuitively. To this end, the number of panels in a stack symbol is not fixed, but the number of stack symbols rather corresponds to the number of POI-symbols assigned to the combination symbol. If the size or thickness of the stack symbol is altered accordingly, the user has an intuitive impression of how many Points of Interest lie closely adjacent to one another in the corresponding local area. In this context, it would also be possible to realize stack thickness classes, according to which, e.g., a number of 8-10 POI-symbols is respectively represented by the same stack thickness.

With respect to the display of map images on navigation systems, a distinction is drawn between 2D images and 3D images. Naturally, a 3D image also consists of the two-dimensional representation that, however, is perspectively tilted by a certain angle in order to provide the visual impression of a three-dimensional image. The inventive display of the combination symbols is suitable for 2D images, as well as for 3D images.

If the combination symbol is displayed in a 2D image, the display area should be displayed such that it lies on the stack symbol. This provides the visual impression that the display area just forms the top panel of the stack symbol. The remaining panels of the stack symbol are largely covered by the display area such that only the protruding edges of the panels lying under the display area can be recognized.

If the stack symbol is displayed in a tilted 3D image, the display area should not be displayed such that it lies on the stack symbol because this would impair the recognizability due to the perspective representation. In a tilted 3D image of the combination symbol, it is therefore advantageous to display the display area such that it stands on the stack symbol in order to ensure an adequate recognizability of the POI-symbol displayed in the display area despite the perspective representation.

In a 3D image, it is, in contrast to a 2D image, not absolutely imperative that the individual panels of the stack symbol largely cover one another and only the protruding edge is visible. If the individual panels of the stack symbol are spaced apart by a sufficient distance, it is also possible, in particular, to display the upper side of the individual panels in 3D images. According to one preferred embodiment of the invention, it is therefore proposed to also display one respective POI-symbol assigned to the combination symbol on the panels of the stack symbol. In other words, this means that the panels of the stack symbol are not displayed in a strictly predetermined fashion in this variation, for example, monochromatic, but that one respective POI-symbol can be displayed in accordance with the display area. However, the POI-symbol displayed on the panels differs from the POI-symbol displayed in the display area in that the panels are merely displayed perspectively.

The individual POI-symbols can essentially be displayed in the display area of the combination symbol in any chronology. In this case, it would also be conceivable to realize variations, in which the individual POI-symbols are displayed for different periods of time. However, it is usually advantageous to display the POI-symbols in the display area in a periodically alternating fashion, wherein each individual POI-symbol should be displayed for such a period of time that the user is also able to read the POI-symbols at a glance. The sequence of the POI-symbols can be strictly predetermined, for example, in dependence on certain criteria. Alternatively, it would also be conceivable to select the POI-symbols to be displayed by means of a random generator in order to realize a random sequence.

The utilization of combination symbols is of particular importance in the display of Points of Interest, all of which are situated in a multi-level building, for example, a high-rise building. In these instances, it may occur that multiple POIs have to be displayed at the same location in the map image. If this display is realized in accordance with the invention by utilizing a combination symbol and an alternating display of the POI-symbols assigned to the combination symbol, it is particularly advantageous if the chronology of the POI-symbols corresponds to the vertical sequence of the POIs. In this sequence, for example, the top Point of Interest may be displayed as the first POI-symbol in the display area and the other Points of Interest are then sequentially displayed in accordance with their arrangement from the top level to the bottom level of the building. Naturally, it would also be conceivable to structure this sequence from the bottom level to the top level of the building and to display the corresponding POI-symbols successively.

Alternatively or additionally to such a direct sorting of the POI-symbols, it would also be conceivable to assign a display priority to the different Points of Interest. In this case, the individual POI-symbols are displayed in dependence on the display priority of the respectively assigned Points of Interest. The display priority can be predefined by the user such that certain POI-categories or individual POI-symbols (e.g., those stored in the address book) are displayed first. In POI-displays that only rotate due to a user interaction or movement, the display priority also makes it possible to predefine the POI-symbol that is displayed when the POI-display is not rotating.

It is also proposed that not only the POI-symbol of a POI is displayed, but also additional information in the form of auxiliary symbols that indicate, for example, the attributes of the POI (24 h filling station, company logo). The method is also suitable in this respect, wherein these auxiliary symbols are either also displayed in a staggering fashion, namely even if only one POI exists at the respective location, or only displayed adjacent to the POI-symbol if the rotating display is activated generally or in this map region.

Different aspects of the invention are schematically displayed in the figures and are described in an exemplary fashion below.

### BRIEF DESCRIPTION OF THE DRAWINGS

FIG. 1 is a first embodiment of a combination symbol for use in a 2D image;

FIG. 2 is a second embodiment of a combination symbol for use in a 2D image;

FIG. 3 is a first embodiment of a combination symbol for use in a 3D image;

FIG. 4 is a second embodiment of a combination symbol for use in a 3D image;

FIG. 5 is a third embodiment of a combination symbol for use in a 3D image;

FIG. 6 is a map image with several combination symbols in the form of a 2D image;

FIG. 7 is a map image with several combination symbols in the form of a 3D image;

FIG. 8 is a map image of a mobile navigation device with a combination symbol in a first operating state, and

FIG. 9 is the map image according to FIG. 8 in a second operating state.

### DETAILED DESCRIPTION OF THE EXAMPLE EMBODIMENTS

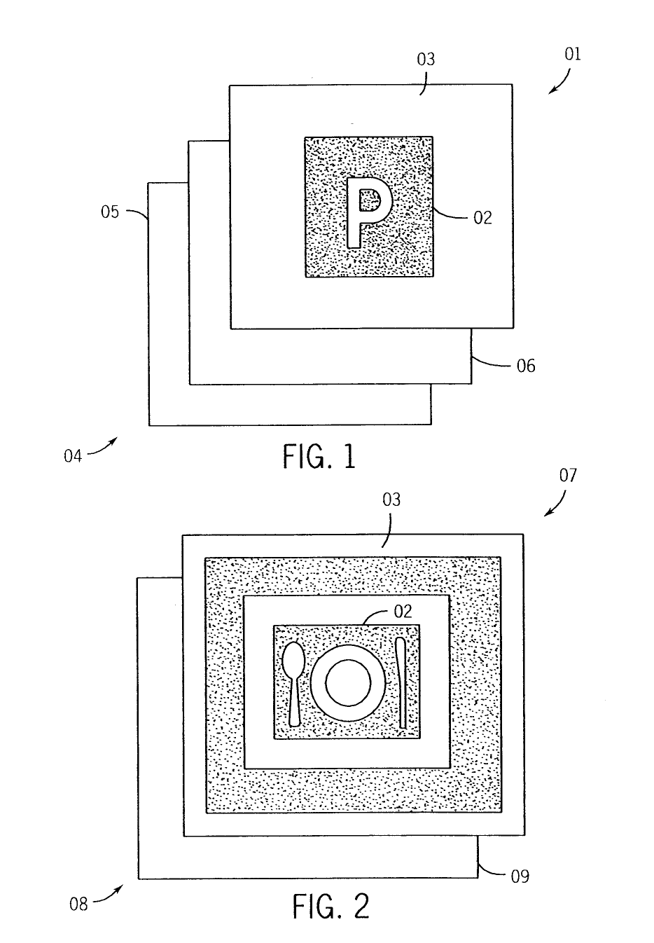

FIG. 1 shows a combination symbol 01 for jointly displaying several POI-symbols 02. The combination symbol 01 comprises a display area 03, on which the different POI-symbols assigned to the combination symbol are displayed in an alternating fashion. The combination symbol 01 furthermore comprises a stack symbol 04 that is composed of two panels 05 and 06 in the embodiment shown in FIG. 1.

Since the combination symbol 01 is intended for being displayed in 2D images, the display area 03 is arranged such that it lies on the panels 05 and 06 of the stack symbol 04. Consequently, the display area 03 almost completely covers the panels 05 and 06 of the stack symbol 04 and only the edges of the panels 05 and 06 of the stack symbol 04 protrude over the display area 03.

FIG. 2 shows a second embodiment 07 of a combination symbol that is also intended for being displayed in 2D images. POI-symbols 02 can also be displayed in an alternating fashion in the display area 03 of the combination symbol 07. The stack symbol 08 of the combination symbol 07 consists of only one panel 09 in the example shown.

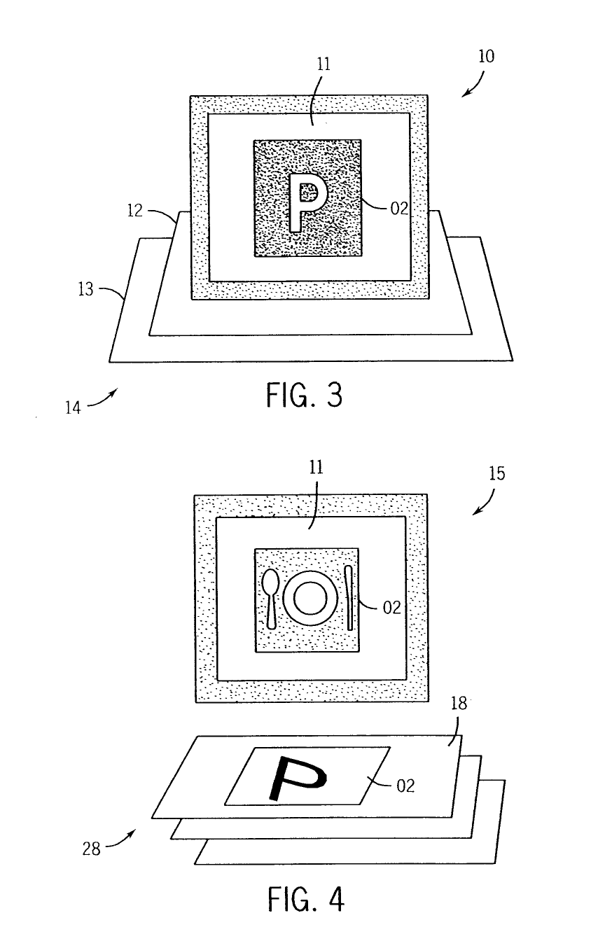

FIG. 3 shows another embodiment 10 of a combination symbol that is intended for being displayed in 3D images. The display area 11 for the alternating display of the POI-symbols 02 is arranged such that it stands on the lying panels 12 and 13 of the stack symbol 14.

FIG. 4 shows another variation 15 of a combination symbol. The display area 11 with the alternating POI-symbols 02 is arranged so far from the stack symbol 28 displayed thereunder that the upper side of the top panel 18 of the stack symbol 28 can be easily recognized. During the display of the combination symbol 15, POI-symbols 02 are also shown in an alternating fashion on the upper side of the top panel 18 of the stack symbol 28.

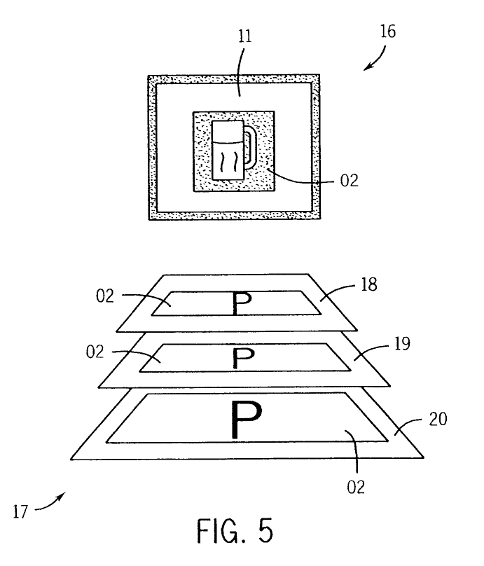

FIG. 5 shows an embodiment 16 of a combination symbol with a display area 11 for displaying POI-symbols 02 exhibiting a stack symbol 17. In this stack symbol 17, the distance between the panels 18, 19 and 20 is so large that the upper sides of the lower panels 19 and 20 are also easily recognizable. Consequently, it is possible to respectively display POI-symbols 02 on all panels 18, 19 and 20 of the stack symbol 17.

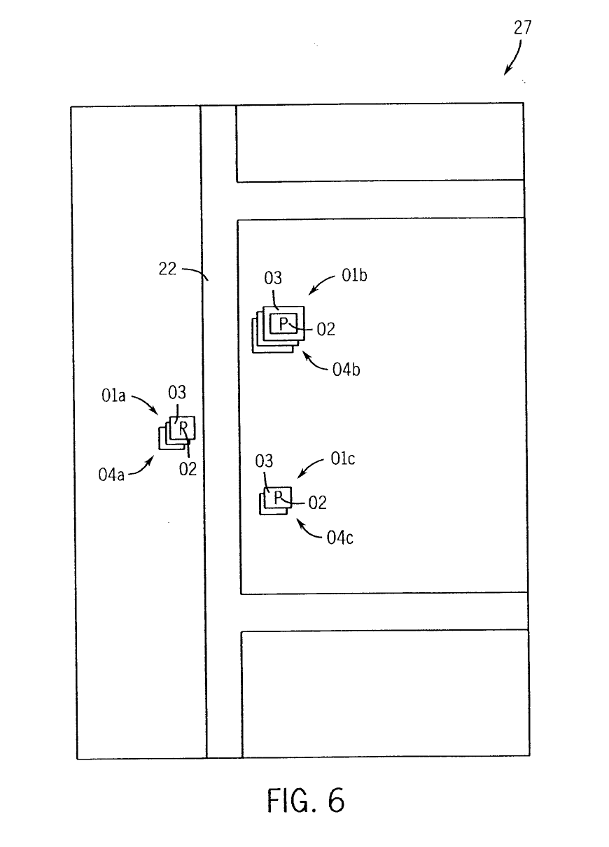

FIG. 6 shows an example of a 2D map image 21 as it could be displayed, for example, on the LCD monitor of a mobile navigation device. The roads 22 in the geographic area shown are displayed in the map image 21. The number of Points of Interest along the roads 22 is so high that the different POI-symbols 02 cannot be individually displayed adjacent to one another. For that reason, combination symbols 01 are shown in the map image 21, wherein the respective display areas 03 of said combination symbols alternately display the POI-symbols assigned to the individual combination symbols 01a, 01b and 01c. Three POI-symbols are respectively assigned to the two combination symbols 01a and 01b such that the stack symbols 04a and 04b used respectively comprise two panels 05 and 06. Consequently, the number of panels of the stack symbols 04a and 04b exactly corresponds to the number of POI-symbols assigned to the combination symbols 01a and 01b-1. The user therefore has the intuitive impression that the stack composed of the display area 03 and the stack symbols 04a and 04b comprises three elements that represent the three POI-symbols. The combination symbol 01c, in contrast, only symbolizes two POI-symbols such that the stacks symbol 04c used only comprises one panel 05.

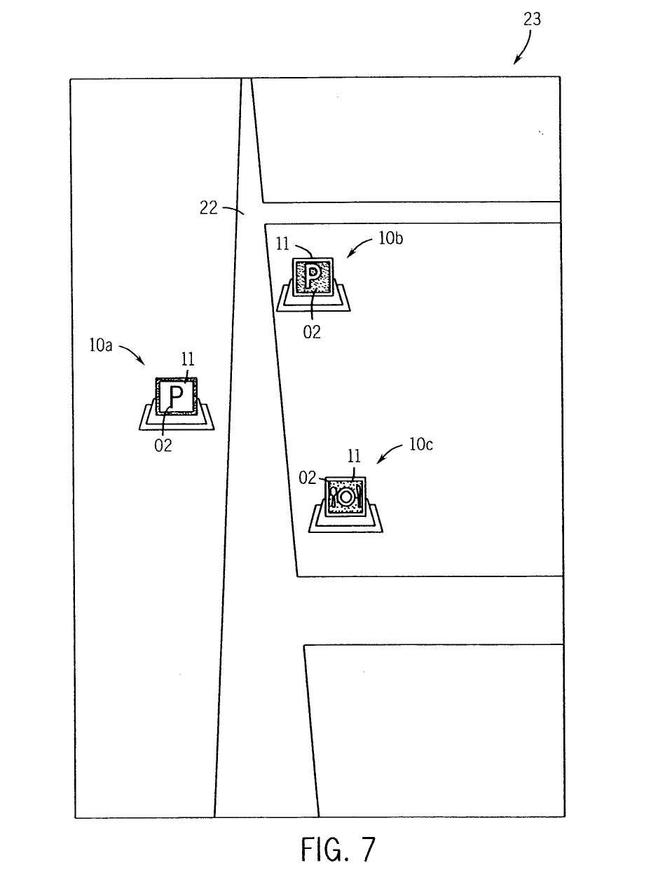

FIG. 7 shows a 3D map image 23 as it can be displayed on an LCD monitor of the mobile navigation device. The different POI-symbols 02 are alternately displayed in the display areas 11 of combination symbols 10a, 10b and 10c. The display area 11 of the combination symbol 10a is inversely illuminated and shows the POI-symbol 02 with inverse coloring.

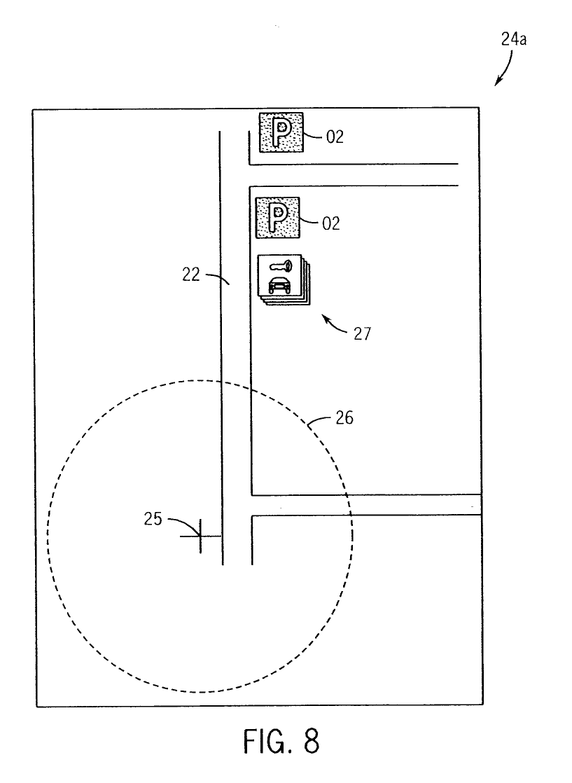

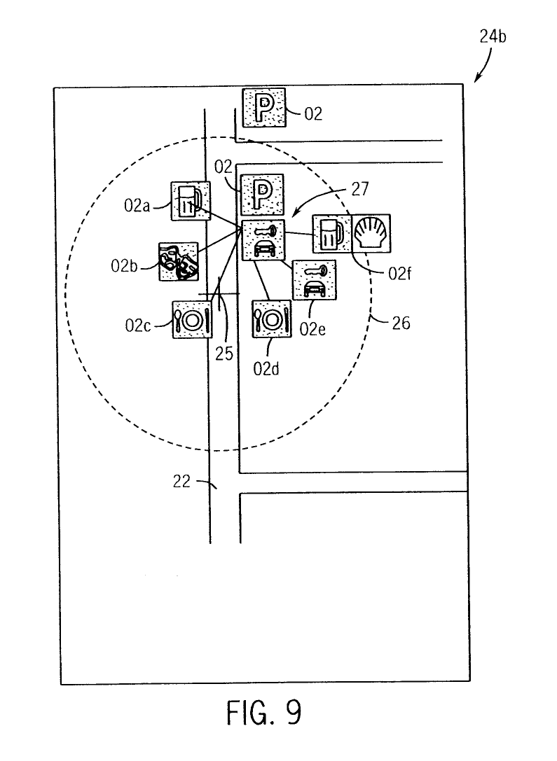

FIG. 8 and FIG. 9 respectively show a 2D map image 24a and 24b with a combination symbol 27. Other POI-symbols 02 are conventionally displayed adjacent to the combination symbol 27.

FIG. 8 and FIG. 9 also show a graticule 25 that forms the center of a circle 26. In this case, the circle 26 is merely displayed for reasons of better recognizability and is usually not displayed on the display device of the navigation system.

According to one variation, the position of the graticule 25 and the assigned circle 26 can be moved over the map image 24 by user interaction, for example, by moving a mouse pointer. According to a second variation, it would also be conceivable that the graticule 25 always corresponds to the current position of the navigation device.

As long as the graticule 25 is located relatively far from the combination symbol 27, the individual POI-symbols 02a to 02f assigned to the combination symbol are alternately displayed in the display area of the combination symbol 27 in a rotating fashion.

Once the graticule 25 approaches the combination symbol 27 such that the combination symbol 27 lies within the circle 26 as shown in FIG. 9, the combination symbol 27 is accessed and the display of the POI-symbols changes. This change causes all POI-symbols 02a to be simultaneously displayed adjacent to one another in order to directly provide the user with a complete overview of the POIs at the corresponding location for this approach.

In order to make clear that all POI-symbols displayed belong to one location, it is advantageous to identify the POI-symbols as belonging together. This is elucidated in. FIG. 9 with star-shaped lines that connect the POI-symbols to the location. Alternatively or additionally, a frame may also be drawn around the fanned-out POI-symbols. After being fanned out, the POI-symbols may essentially be positioned arbitrarily, wherein an orderly alignment would also be conceivable in addition to the centrally shifted variation.

While there has been shown and described what are at present considered the preferred embodiment of the invention, it will be obvious to those skilled in the art that various changes and modifications can be made therein without departing from the scope of the invention defined by the appended claims. Therefore, various alternatives and embodiments are contemplated as being within the scope of the following claims particularly pointing out and distinctly claiming the subject matter regarded as the invention.

1. A method for operating a navigation system, said method comprising:
a) calculating and displaying a map image on a display device, wherein the map image represents at least a section of a geographic area;
b) selecting locations to be highlighted (Points of Interest, POI) that lie in the region of the geographic area displayed and are respectively assigned to one POI-symbol in the map image from a data base, and
c) displaying the POI-symbols in the map image, wherein the POI-symbols that symbolize the locations to be highlighted within a common local area are displayed in the form of a common combination symbol such that one combination symbol respectively represents several POI-symbols, in which the combination symbol features at least one display area, in which at least one POI-symbol can be displayed, wherein the POI-symbols assigned to the combination symbol are alternately displayed in the display area.

2. The method according to claim 1, in which the display area of the combination symbol can be switched off, particularly by actuating an actuating element, wherein no alternating display of POI-symbols takes place in the switched-off state.

3. The method according to claim 1, in which the display area of the combination symbol is switched off in a basic state and the alternating display of the POI-symbols is started by accessing the combination symbol.

4. The method according to claim 1, in which the POI-symbols are crossfaded during their alternating display in the display area of the combination symbol.

5. The method according to claim 1, in which the combination symbol can be accessed in order to influence the display of the combination symbol and/or the assigned POI-symbols.

6. The method according to claim 5, in which the combination symbol can be accessed by the actuation of an actuating element by the user.

7. The method according to claim 5, in which the navigation system is realized in the form of a mobile navigation device, by means of which the current position of the navigation device can be determined, wherein the combination symbol can be accessed by the approach of the current position to the combination symbol.

8. The method according to claim 5, in which several POI-symbols, particularly all POI-symbols assigned to the combination symbol, are simultaneously displayed adjacent to one another as a result of accessing the combination symbol.

9. The method according to claim 1, in which the combination symbol not only comprises the display area, but also a stack symbol that symbolizes a stack with at least one panel, wherein the display area is displayed above the stack symbol.

10. The method according to claim 9, in which the number of panels of the stack symbol depends on the number of POI-symbols assigned to the combination symbol.

11. The method according to claim 9, in which the combination symbol is displayed in a 2D image, wherein the display area is displayed such that it lies on the stack symbol.

12. The method according to claim 11, in which the stack symbol is displayed at least slightly larger than the display area such that at least one edge of the stack symbol protrudes over the edge of the display area.

13. The method according to claim 9, in which the combination symbol is displayed in a tilted 3D image, wherein the display area is displayed such that it stands on the stack symbol.

14. The method according to claim 1, in which the combination symbol is displayed in a tilted 3D image, wherein one respective POI-symbol assigned to the combination symbol is displayed at least partially, particularly alternately, on at least one panel of the stack symbol.

15. The method according to claim 1, in which the POI-symbols are displayed in the display area in a periodically alternating fashion, particularly in a certain sequence.

16. The method according to claim, in which the sequence in which the POI-symbols are displayed in the display area is defined by the vertical sequence of locations to be highlighted (POI) that lie on top of one another, particularly in multi-level buildings.

17. The method according to claim 1, in which a display priority is respectively assigned to the locations to be highlighted (POI) and/or the POI-symbols, wherein the POI-symbols assigned to a combination symbol are displayed in the display area of the combination symbol in dependence on the display priority.

18. The method according to claim 1, in which at least one auxiliary symbol is assigned to a POI-symbol, wherein the POI-symbol and the auxiliary symbol are alternately displayed in the display area of the combination symbol.
